(19) United States
(12) Patent Application Publication
(10) Pub. No.: US 2025/0245637 A1
(43) Pub. Date: Jul. 31, 2025

(54) SYSTEMS AND METHODS FOR DEPOSIT TRANSFER CUSTOMIZATION

(71) Applicant: Wells Fargo Bank, N.A., San Francisco, CA (US)

(72) Inventors: Marjorie Summit, San Francisco, CA (US); Darlene Goins, San Francisco, CA (US)

(73) Assignee: Wells Fargo Bank, N.A., San Francisco, CA (US)

(21) Appl. No.: 18/424,548

(22) Filed: Jan. 26, 2024

(51) Int. Cl. G06Q 20/10; G06Q 40/02

(52) U.S. Cl. CPC G06Q 20/102; G06Q 40/02

(57) ABSTRACT

A system includes a processing circuit configured to determine a billing period based on a billing frequency corresponding to a bill payment. The processing circuit is further configured to determine deposits that will be made into a first account that will occur during the billing period. The processing circuit is further configured to generate transfer preferences for the deposits. The processing circuit is further configured to receive an indication that a deposit has been received by the first account. The processing circuit is further configured to transfer an amount associated with the deposit from the first account to a second account, wherein the second account is associated with the bill payment and the amount transferred is based on a bill payment amount.

### BACKGROUND

People typically have difficulty managing bill payments. For example, in some instances, a person may receive a deposit and spend an entire value of the deposit before allocating a portion of the deposit to the bill payments. Because a person may be negatively affected by not making a bill payment through late fees, service penalties, or legal consequences, people strive to better manage their bill payments.

### SUMMARY

Some arrangements relate to a system. In some arrangements, the system includes a processing circuit. In some arrangements, the processing circuit includes memory and one or more processors. In some arrangements, the processing circuit is configured to determine a billing period based on a billing frequency corresponding to a bill payment. In some arrangements, the processing circuit is further configured to determine a portion of deposits into a first account that will occur during the billing period. In some arrangements, the portion of the deposits have not yet occurred. In some arrangements, the processing circuit is further configured to generate transfer preferences for the portion of the deposits based on receiving the transfer preferences including amounts associated with each deposit of the portion of the deposits that will be allocated to the bill payment. In some arrangements, the preference data is received from a graphical user interface (GUI) of a user device. In some arrangements, the processing circuit is further configured to receive an indication that a deposit of the portion of the deposits has been received by the first account. In some arrangements, the processing circuit is further configured to transfer an amount associated with the deposit from the first account to a second account. In some arrangements, the second account is associated with the bill payment and the amount transferred is based on a bill payment amount.

Some arrangements relate to a system. In some arrangements, the system includes a processing circuit. In some arrangements, the processing circuit includes memory and one or more processors. In some arrangements, the processing circuit is configured to determine a deposit range for deposits into a first account. In some arrangements, the deposit range includes a range of typical values of the deposits. In some arrangements, the processing circuit is further configured to configure transfer preferences for a portion of the deposits into the first account based on receiving preference data corresponding with the portion of the deposits. In some arrangements, the processing circuit receives the preference data from a graphical user interface (GUI) of a user device. In some arrangements, the portion of the deposits have not yet occurred. In some arrangements, the processing circuit is further configured to receive an indication that one of the deposits in the portion of the deposits has been received by the first account. In some arrangements, the processing circuit is further configured to validate that the one of the deposits is within the deposit range. In some arrangements, responsive to the one of the deposits not being within the deposit range the processing circuit is further configured to generate and provide a notification to the GUI of the user device. In some arrangements, the notification includes that the one of the deposits is at least one of below the deposit range or above the deposit range. In some arrangements, responsive to the one of the deposits being within the deposit range the processing circuit is further configured to transfer the amount associated with the one of the deposits from the first account to a second account. In some arrangements, the second account is associated with a bill payment and the amount transferred is based on a bill payment amount.

Some arrangements relate to a method. In some arrangements, the method includes determining a billing period based on a billing frequency corresponding to a bill payment. In some arrangements, the method further includes determining deposits that will be made into a first account that will occur during the billing period. In some arrangements, the deposits have not yet occurred. In some arrangements, the method further includes configuring transfer preferences for the portion of the deposits that have not yet occurred based on receiving preference data corresponding to the portion of the deposits. In some arrangements, the preference data is received from a graphical user interface (GUI) of a user device. In some arrangements, the transfer preferences include an amount associated with each deposit. In some arrangements, the method further includes receiving an indication that a deposit has been received by the first account. In some arrangements, the method further includes transferring the amount associated with the deposit from the first account to a second account. In some arrangements, the second account is associated with the bill payment and the amount transferred is based on a bill payment amount.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing environment including a transfer system, according to example embodiments.

FIG. 2 is a block diagram illustrating an example computing system suitable for use in the example embodiments described herein.

FIG. 3 is a flow diagram of a method for transferring amounts from deposits, according to example embodiments.

FIG. 4 is an illustration of a configuration of a user interface generated by the transfer system of FIG. 1, according to example embodiments.

FIG. 5 is an illustration of an additional configuration of a user interface generated by the transfer system of FIG. 1, according to example embodiments.

FIG. 6 is an illustration of an additional configuration of a user interface generated by the transfer system of FIG. 1, according to example embodiments.

FIG. 7 is an illustration of an additional configuration of a user interface generated by the transfer system of FIG. 1, according to example embodiments.

FIG. 8 is an illustration of an additional configuration of a user interface generated by the transfer system of FIG. 1, according to example embodiments.

FIG. 9 is an illustration of an additional configuration of a user interface generated by the transfer system of FIG. 1, according to example embodiments.

FIG. 10 is an illustration of an additional configuration of a user interface generated by the transfer system of FIG. 1, according to example embodiments.

FIG. 11 is an illustration of an additional configuration of a user interface generated by the transfer system of FIG. 1, according to example embodiments.

FIG. 12 is an illustration of an additional configuration of a user interface generated by the transfer system of FIG. 1, according to example embodiments.

### DETAILED DESCRIPTION

Referring generally to the figures, systems, and methods for using customizable amounts from deposits for bill payments are disclosed according to various embodiments herein. In some embodiments, the systems and methods enable a user to freely customize an amount from a deposit to allocate to a bill payment on a deposit by deposit basis. Additionally, in some instances, the systems and methods generate a variation between a deposit frequency associated with the deposits and a billing frequency associated with the bill payment and may modify the billing frequency to eliminate the variation, such that the deposits occur at the same frequency as the bill payments.

In some instances, the systems and methods described herein include specific rules for using the amounts from a deposit for bill payments when a value of a deposit is outside of a typical value range for the deposits. Additionally, in some instances, the systems and methods described herein estimate that an occurrence when the value of a deposit in the future will be outside of the typical value range for the deposits such that the user may be made aware that the value of the deposit in the future will be outside of the typical value range for the deposits. For example, in some instances, the systems and methods described herein use one or more trained machine learning models to estimate that a deposit in the future that will have a value outside of the typical value range for the deposits.

Accordingly, the systems and methods described herein provide a variety of improvements to deposit management systems. For example, traditional deposit management systems have not been configured to enable a user to freely customize amounts of deposits to allocate for bill payments on a deposit by deposit basis. As such, a person may not be able to control the amounts of the deposits allocated for bill payments with the flexibility that the person desires. Further, even if the person was able to control the amounts of the deposits allocated for bill payments on a deposit by deposit basis, traditional deposit management systems have not included specific rules relating to modifying the amounts of the deposits allocated for the bill payments based on a value of the deposits being outside of a typical value range for the deposits.

The systems and methods described herein solve these issues by providing users with an ability to allocate an amount from upcoming deposits for bill payments, such that the amount from each upcoming deposit may be automatically transferred to a bill payment account or towards the bill payment after being received in an account of the user. In some arrangements, an amount associated with a deposit may be transferred from the account of the user to the bill pay account or towards the bill payment after being received in the account of the user and if the deposit is withing a typical range value for the deposits. In some arrangements, a billing frequency of the bill payments may be modified to match a deposit frequency of the deposits such that each of the bill payments may correspond with one of the deposits. In some arrangements, the user may be notified if a value of a deposit is estimated to be outside of a typical value range for the deposits. In some arrangements, if a value of a deposit is outside of the typical value range for the deposits, the user may modify an amount associated with the deposit that is allocated for a bill payment. In some arrangements, if a value of a first deposit is outside of the typical value range for the deposits, the user may modify a first amount associated with the first deposit and a second amount associated with a second deposit that are both allocated for a bill payment. As such, a person associated with the deposits and the bill payments may be able to customize amounts from upcoming deposits to allocate towards bill payments on a deposit by deposit basis to actively control the amounts from the deposits that are used to make the bill payments. The person associated with the deposits may also be notified when values of upcoming deposits are estimated to be outside of the typical value range of the deposits so that the person can adjust amounts from the upcoming deposits to ensure that the bill payments are made and that a sufficient amount of the deposits remains with the person.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

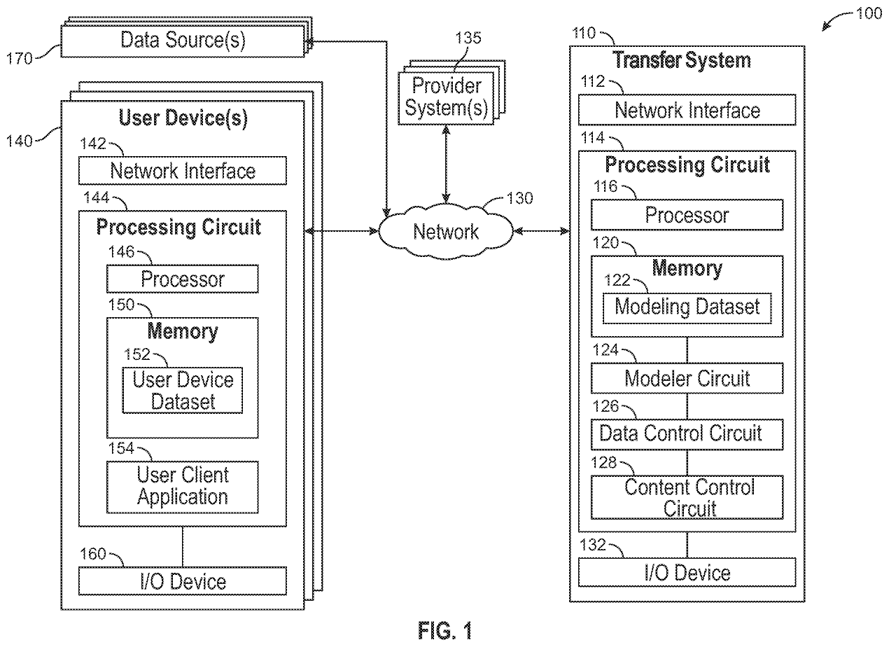

Referring to FIG. 1, a block diagram of a computing environment 100 including a transfer system 110 is shown, according to potential embodiments. The transfer system 110 can be associated with a provider, such as a service provider, bank, or financial institution (FI). The computing environment 100 further includes one or more user devices (e.g., user device 140), one or more data sources (e.g., data source 170), and one or more provider systems (e.g., the provider system 135). In some embodiments, the transfer system 110, user device 140, and data source 170 are communicatively coupled. The various components of the computing environment are in communication with each other and are connected by a network 130.

Although the various systems and devices are shown in FIG. 1 as being singular, it will be understood that, in some instances, the computing environment 100 includes one or multiple of any of the various illustrated systems and/or devices, as desired for a given application. Similarly, while the following descriptions of the various systems and devices are largely provided in terms of single systems or devices, it will be appreciated that these descriptions are similarly applicable to any additional corresponding systems and/or devices (e.g., additional of the provider systems 135, additional of the user devices 140, and so on).

The transfer system 110 may be operated by a provider, such as an entity, a consultant, a retailer, a service provider, and so on. The transfer system 110 includes a network interface 112 that connect the transfer system 110 to the network 130. The network interface 112 facilitates secure communications between the transfer system 110 and various other components of the computing environment 100. The network interface 112 also facilitates communication with other entities (e.g., provider systems 135, etc.), such as other banks, healthcare systems, and so on. Further, in some arrangements, the network interface 112 includes cryptography capabilities to establish a secure or relatively secure communication session in which data communicated over the session is encrypted.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The processor 116 may be implemented as one or more application specific integrated circuits (ASICs), field programmable gate arrays (FPGAs), a group of processing components, or other suitable electronic processing components. The memory 120 may be a device for storing data and/or computer code. The memory 120 may store data associated with a variety of application programs ran by the transfer system 110. One such application may be to provide data to the modeler circuit 124, data control circuit 126, and content control circuit 128. The memory 120 can store a variety of data related to the modeler circuit 124 in a modeling dataset 122, which may be used by the modeler circuit 124 as discussed herein.

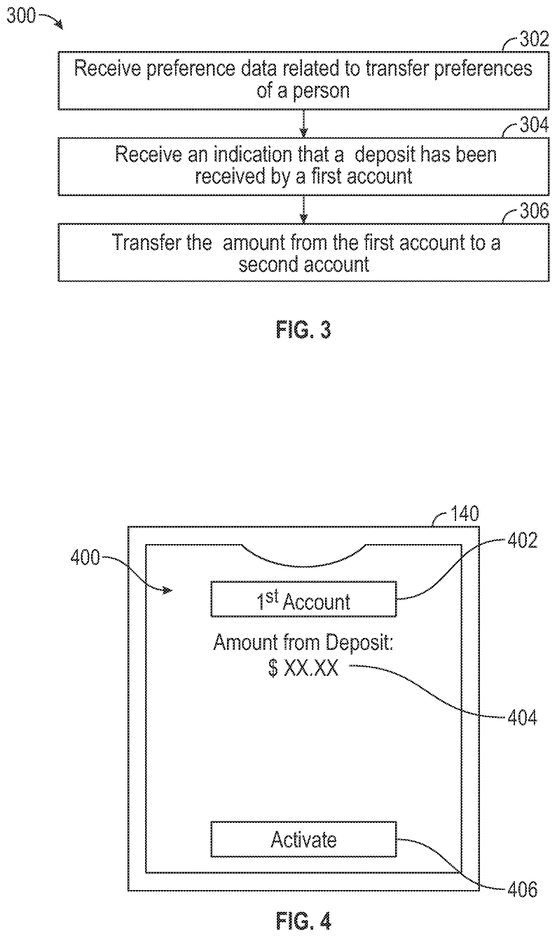

The modeler circuit 124 is structured or configured to perform a variety of the functionalities described herein. As will be described in detail below, with regard to FIG. 3, the modeler circuit 124 is configured to determine billing periods based on a billing frequency corresponding to a bill payment. As will similarly be described below, in some instances, the modeler circuit 124 is further configured to determine the billing frequency corresponding to the bill payment based on previous transfers from a first account to a second account. In some instances, the modeler circuit 124 is further configured to determine a deposit frequency for a set of deposits based on a portion of the deposits that have previously been deposited into an account. In some instances, the modeler circuit 124 is configured to model the deposit frequency with the billing frequency to generate a variation between the deposit frequency and the billing frequency. In some embodiments, the modeler circuit 124 is configured to determine a deposit range for deposits into an account the deposit range including a range of typical values of the deposits. In some embodiments, the modeler circuit 124 is configured to determine an out of range deposit frequency corresponding to deposits into an account that are not within the deposit range based on previous deposits into the account that were not within the deposit range. In some embodiments, the modeler circuit 124 is configured to estimate that a future deposit will not be within the deposit range based on the out of range deposit frequency.

The data control circuit 126 is configured to fuse data, including operations to generate various data structures stored in the memory 120 and used by the various circuits described herein. The data control circuit 126 can also be configured to receive data from multiple sources (e.g., the data sources 170, the provider systems 135, the user devices 140, etc.) and aggregate the data into various data structures stored in the memory 120.

The content control circuit 128 is configured to generate content for displaying to users. The content can be selected from various resources (e.g., a request for a bill amount associated with a bill payment from the data control circuit 126). The content control circuit 128 can also be structured to provide content (e.g., via a graphical user interface (GUI)) to the user device 140 over the network 130, for display. The content can also include actionable items that the user may select or otherwise manipulate. The content can be selected from various resources (e.g., from the data control circuit 126, from the memory 120, etc.).

The content generated by the content control circuit 128 can include customized dashboards, such as those described in detail below, with reference to FIGS. 4-12. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with one or more assets such as amounts, photographs, or videos, descriptions, and/or others. In certain embodiments, the transfer system 110 includes an application programming interface (API) and/or a software development kit (SDK) that facilitate the integration of other applications with the transfer system 110. For example, the transfer system 110 is configured to utilize the functionality of the user device 140 interacting through an API.

The content control circuit 128 can generate an interface corresponding to variations between billing frequencies and deposit frequencies (e.g., generated by the modeler circuit 124). In some embodiments, the interface may include elements illustrating the variations between the billing frequencies and the deposit frequencies. The elements may include a recommendation for the user request a modification of the billing frequencies to eliminate the variation. For example, the interface may include a billing frequency that is between longer than a deposit frequency and a recommendation that the user request a modification of the billing frequency.

The input/output device 132 is structured to receive communications from and provide communications to users associated with the transfer system 110. The input/output device 132 can be structured to exchange data, communications, instructions, etc. with an input/output component of the transfer system 110 (e.g., a mouse, a monitor, a keyboard, etc.). As such, the input/output device 132 may provide an interface for the user to interact with various applications stored on the transfer system 110.

The user device 140 is owned, operated, controlled, and/or otherwise associated with a person (e.g., a person looking to simplify their asset portfolio, etc.). In some embodiments, the user device 140 may be or may include, for example, a desktop or laptop computer (e.g., a tablet computer), a smartphone, a wearable device (e.g., a smartwatch), a personal digital assistant, and/or any other suitable computing device. The user devices 140 may each include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the transfer system 110. Therefore, it should be understood that the description of the network interface 112, the processing circuit 114, and the input/output device 132 of the transfer system 110 provided above may be similarly applied to the network interface 142, the processing circuit 144, and the input/output device 160 of each of the user devices 140. The network interface 142 may similarly facilitate secure communications between the user device 140 and various other components of the computing environment 100. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150. The variety of application programs and associated data may be stored as user device dataset 152.

Additionally, processing circuit 144 of each of the user devices 140 may each store, in the memory 150, and execute (“run”) user client applications 154, such as an Internet browser presenting websites and/or applications provided or authorized by entities implementing or administering any of the computing systems in computing environment 100 to enable the customer to perform or otherwise interact with various methods and operations described herein. For example, in some instances, the user client applications 154 comprise a provider client application (e.g., a financial institution banking application) provided by and at least partly supported by the transfer system 110 and configured to enable various functionality described herein. In some instances, the user client applications 154 comprise a provider client application provided by and at least partly supported by the provider system 135 and configured to enable various functionality described herein.

In some instances, the user client application 154 is additionally coupled to various components within the computing environment 100 (e.g., the transfer system 110, the provider system 135) via one or more application programming interfaces (APIs) and/or software development kits (SDKs) to integrate one or more features or services provided by the various components to enable the various methods and operations described herein. For example, in some instances, a provider client application provided to the user device 140 by the transfer system 110 implements various functionality of the provider system 135 via one or more APIs and/or SDKs to allow for various functionality and/or information provided and/or stored by the provider system 135 to be utilized or otherwise implemented within the context of the provider client application.

Additionally, the user client application 154 is configured to output information to a display of user device 140 regarding information received from the transfer system 110. For example, the user client application 154 is configured to communicate with a user interface to show graphics regarding content associated with a deposit, such as a graph, a valuation, or a description. Further, a user response to a display of user device 140 regarding information from the transfer system 110 can send a message, task, or instruction to the transfer system 110 via the network 130 that allows for the modeling dataset 122, modeler circuit 124, data control circuit 126, and/or content control circuit 128 to be perform an update.

The data sources 170 can provide data to the transfer system 110 and/or user device 140. In some arrangements, the data sources 170 can be structured to collect data from other devices on network 130 (e.g., user devices 140 and/or other third-party devices) and relay the collected data to the transfer system 110 and/or user device 140. In some embodiments, the transfer system 110 may request data associated with specific data stored in the data source (e.g., data sources 170). For example, in some arrangements, the data sources 170 can support a search or discovery engine for Internet-connected devices. The search or discovery engine may provide data from other providers that, when used to update a billing frequency associated with a bill payment (e.g., billing frequency used by the modeler circuit 124 based on data from the modeling dataset 122), will cause an update to a portion of deposits that will occur during a billing period.

With reference again to FIG. 1, the provider system 135 is controlled by, managed by, owned by, and/or otherwise associated with a provider, such as a bank, a credit union, an appraiser, a health care institution, a governmental institution, or other institutions (e.g., credit card companies, financial institutions (FI), insurance institutions, etc.). In some embodiment, the provider system may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. In some instances, the provider system 135 includes and/or has various other devices communicably coupled thereto, such as, for example, desktop or laptop computers (e.g., tablet computers), smartphones, wearable devices (e.g., smartwatches), and/or other suitable devices.

The provider system 135 may also store various individual information, billing information, billing frequencies, deposit information, deposit frequencies', and various other information. In some instances, the provider system 135 is configured to retrieve and transmit various customer data stored within the provider system 135 to various components within the computing environment 100 to enable the various methods, functions, and processes described herein.

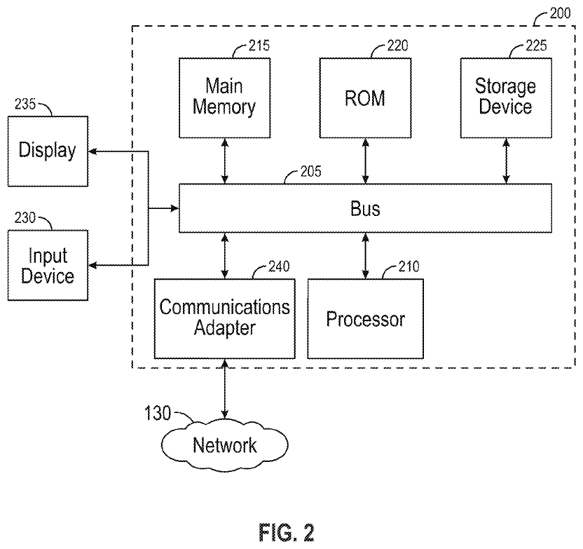

Referring now to FIG. 2, a depiction of a computing system 200 is shown. The computing system 200 can be used, for example, to implement the computing environment 100, the transfer system 110, provider systems 135, user devices 140, data sources 170, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk, or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In some arrangements, the display 235 of the input device 230 has a touch screen. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with the network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 3, a flowchart for a method 300 of transferring amounts from deposits to bill payments is shown, according to some embodiments. Transfer system 110 can be configured to perform method 300. Further, any computing device described herein can be configured to perform method 300. The GUI of method 300 may be provided by and/or accessible by the user client application 154 and content control circuit 128, for example. The method 300 may be performed by the transfer system 110 or the user device 140, described above pertaining to FIGS. 1 & 2. In some embodiments, method 300 begins in response to receiving, by a user deice (e.g., user device 140) and/or through a user client application (e.g., user client application 154), data from a dataset (e.g., user device dataset 152). The data can include deposit data relating to deposits into an account, bill payment data relating to a bill payment from the account, or user data. In some embodiments, the method 300 begins when the transfer system 110 receives data via the network 130.

The method 300 begins with the processing circuit (e.g., transfer system 110) receiving preference data related to transfer preferences of a person, at step 302. The preference data relates to deposits into an account of the person and may include amounts associated with each of the deposits into the account that should be allocated to a bill payment, a frequency of the deposits into the account, a typical value range of the deposits into the account, or other information relating to the deposits or the bill payment. The deposits may be paychecks received by the person for work performed by the person, pension payments received by the person, dividend payments from stocks owned by the person, or reoccurring deposits that occur at a relatively consistent frequency. For example, in some instances, a user may initiate the method 300 through a user device (e.g., the user device 140) by uploading preference data relating to deposits and a bill payment. In some instances, the preference data may include all of the information relating to the deposits required by the processing circuit to perform method 300 or the modeler circuit 124 may need to receive additional information relating to the deposits from a different source (e.g., the provider system 135, the data source 170, etc.). For example, a user may request to use a transfer system through the user interface of the user device 140 and may also upload preference data relating to amounts associated with each deposit of a portion of deposits that should be allocated to a bill payment. The preference data uploaded by the user may include all of the data required by the processing system to perform method 300 or the modeler circuit 124 may need to receive additional data from a different source (e.g., the provider system 135, the data source 170, etc.).

In some instance, the processing circuit is configured to generate the transfer preferences for the deposits of the person. For example, the processing circuit may configure transfer preferences of the person based on the preference data received from the user. The transfer preferences may include amounts associated with each of the deposits. The amounts associated with each of the deposits may be amounts that are allocated to the bill payment.

In some instances, the processing circuit may receive bill data. The bill data may be uploaded by the user or may be received from a different source. The bill data may relate to the bill payment of the person and may include a name of the bill payment, a recipient of the bill payment, an amount of the bill payment, an account associated with the bill payment, a frequency of the bill payment, or other information relating to the bill payment. The bill data may be used by the processing circuit to coordinate allocating the amounts of the deposits toward the bill payment. For example, in some instances, the processing circuit may utilize the bill data to determine a bill payment account associated with the bill payment In some instances, the bill data uploaded by the user may include all of the information required by the processing circuit or the modeler circuit 124 may need to receive additional data from a different source (e.g., the provider system 135, the data source 170, etc.).

In some instances, the processing circuit may receive account data. The account data may be uploaded by the user or may be received from a different source. The account data may relate to the account of the person and may include a name of the account, an owner of the account, a transaction history of the account, a balance of the account, or other information relating to the account. The account data may be used by the processing circuit to determine patterns relating to the deposits or the bill payment. For example, in some instances, the processing circuit may utilize the account data to determine if the account has sufficient funds to allocate a certain amount of the funds in the account to the bill payment. In some instances, the account data uploaded by the user or shared by the user may include all of the information required by the processing circuit or the modeler circuit 124 may need to receive additional data from a different source (e.g., the provider system 135, the data source 170, etc.).

In some instances, the processing circuit can be further configured to determine a deposit frequency of the deposits into the account of the person. In some instances, the deposit frequency can relate to how frequently the deposits are made into the account. For example, if a person is paid every two weeks then processing circuit will determine that the deposit frequency is biweekly. In some instances, the processing circuit may analyze the account data relating to the account to determine the deposit frequency. For example, the account data may include a deposit that occurs twice a month and is received from a consistent account number. Based on the account data, the processing circuit may determine that the deposit frequency is bi-monthly. In some instances, the processing circuit may be configured to estimate a deposit frequency (e.g., when the deposit is not made constantly). For example, the account data may include a first deposit that occurred on a first date, a second deposit that occurred twelve days after the first deposit, a third deposit that occurred fifteen days after the second deposit, and a fourth deposit that occurred 13 days after the third deposit. Based on the account data, the processing circuit may estimate that the deposit frequency is biweekly due to an average time between deposits being close to two weeks. In other instances, the deposit frequency may be included in the preference data.

In some instances, the processing circuit can be further configured to determine a billing frequency of the bill payment of the person. In some instances, the billing frequency can relate to how frequently the bill payment of the person is due. For example, if a bill payment is due once a month, then the processing circuit will determine that the billing frequency is monthly. In some instances, the processing circuit may analyze the account data relating to the account to determine the billing frequency. For example, the account data may include a transfer that occurs once a month that is allocated to destination associated with the bill payment. Based on the account data the processing circuit may determine that the billing frequency is monthly. In some instances, the processing circuit may be configured to estimate a billing frequency. For example, the account data may include a first transfer that occurred on April 15^{th}, a second transfer that occurred on May 16^{th}, a late fee associated with the second transfer, and a third transfer that occurred June 15^{th}. Based on the second transfer incurring the late fee, the processing circuit may determine that the bill payment is due the 15^{th} of each month and that the bill frequency is monthly. In other instances, the billing frequency may be included in the bill data.

In some instances, the processing circuit is configured to identify a variation between the deposit frequency and the billing frequency. The variation may be related to how often the deposits and the bill payments occur. For example, the variation may be that the deposits occur biweekly and the bill payments occur monthly. The variation may also be related to a deposit date when the deposits occur and a bill payment date when the bill payments occur. For example, the deposits may occur on a tenth day and a twenty-fifth day of a month and the bill payments may occur on a fifteenth day and a last day of the month. In some instances, the variation may be that the deposits occur twice as often as the bill payments. For example, the deposits may occur bimonthly and the bill payments may occur monthly.

In some instances, the processing circuit is configured to modify the billing frequency to eliminate the variation between the deposit frequency and the billing frequency. For example, the processing circuit may adjust the billing frequency, such that there are no variations between the billing frequency and the deposit frequency. For example, a credit card payment for a person may occur once a month and a paycheck for the person may be deposited biweekly, such that the person receives two paychecks during certain months and three paychecks during other months. The processing circuit may modify a payment frequency of the credit card payment to biweekly such that a paycheck frequency of the paychecks is the same as the payment frequency. In some instances, the processing circuit may be configured to modify the bill frequency so that the deposit frequency aligns with the bill frequency. For example, if the deposit frequency is biweekly and the bill frequency is monthly, the processing circuit may be configured to modify the bill frequency to be every four weeks such that the deposit frequency fits evenly into the bill frequency (e.g., two deposits for every one bill payment.).

In some instances, the processing circuit may generate one or more resolution instructions that include a process to eliminate the variation between the deposit frequency and the billing frequency. For example, the processing circuit may model the variation between the deposit frequency and the billing frequency to determine a process that the user would need to follow to eliminate the variation between the deposit frequency and the billing frequency. For example, a trust may pay a person bimonthly and an electric bill of the person may be due once a month. The processing circuit may model the variation between a trust frequency of the trust and an electric bill frequency of the electric bill and determine that the person would need to modify the terms of the trust in order to adjust the trust frequency and eliminate the variation between the trust frequency and the electric bill frequency.

In some instances, the processing circuit may be configured to determine a billing period of the bill payment. The billing period may be a period of time between billing payments. For example, the billing period of the bill payment may be a four week period or the billing period may be a month between specific dates. The processing circuit may be configured to determine the billing period based on the billing frequency and a date of a previous bill payment. For example, a heating bill for a person may have a billing frequency that is monthly and the person may have paid the heating bill on a fifth day of a month. The processing circuit may determine that the billing period of the heating bill is between a sixth day of a first month and the fifth day of a second month based on the billing frequency and the date of the previous bill payment. In some instances, the processing circuit may be configured to determine multiple billing periods (e.g., a first billing period, a second billing period, a third billing period, etc.). Using the heating bill example, the processing circuit may determine that a first billing period is between the sixth day of the first month and the fifth day of the second month, that a second billing period is between a sixth day of the second month and a fifth day of a third month, that a third billing period is between a sixth day of the third month and a fifth day of a fourth month, etc.

In some instances, the processing circuit may be configured to determine a portion of deposits that occur during one of the billing periods. For example, the processing circuit may identify a portion of deposits that have occurred or will occur during the one of the billing periods. For example, a billing period may be a month, a deposit frequency may be biweekly, and a first deposit may have occurred on the first day of the month. The processing circuit may determine that the first deposit, a second deposit that will occur two weeks after the first deposit, and a third deposit that will occur two weeks after the second deposit will occur during the billing period. In some instances, a first portion of deposits that will occur during a first billing period may include a different quantity of deposits than a second portion of deposits that will occur during a second billing period. For example, the deposit frequency could be biweekly, which may result in a first portion of deposits including three deposits that will occur during a first billing period of a first month and a second portion of deposits including two deposits that will occur during a second billing period of a second month. In some instances, first amounts associated with the deposits of the first portion of the deposits are different than second amounts associated with the deposits of the second portion of the deposits.

In some instances, the portion of the deposits are deposits that have not yet occurred. For example, the processing circuit may project a timing of deposits in the future based on dates of previous deposits and the deposit frequency associated with the deposits. By being able to determine a portion of the deposits in a billing period where the portion of the deposits have not yet occurred, the processing circuit may allow for a person to make decisions regarding deposits in the portion of the deposits before the deposits have occurred. In some instances, the processing circuit may be configured to determine the portions of deposits that occur during multiple of the billing periods. For example, a first portion of the deposits could occur during a first billing period and a second portion of the deposits could occur during a second billing period. In some instances, a first quantity of the deposits in the first portion of the deposits does not equal a second quantity of the deposits in the second portion of the deposits. For example, the first billing period may include three of the deposits and the second billing period may include two of the deposits.

In some instances, the preference data may include amounts associated with each deposit of the portion of the deposits that will occur during the billing period. In some instances, the amounts associated with each deposit of the portion of the deposits are amounts that will be allocated to the bill payment. For example, a user may identify that a first amount of a first deposit that will occur during a billing period will be allocated to a bill payment and a second amount of a second deposit that will occur during the billing period will also be allocated to the bill payment. In some instances, the first amount of the first deposit is not equal to the second amount of the second deposit. In some instances, the portion of the deposits may include additional deposits (e.g., a third deposit, a fourth deposit, etc.) and the preference data may include additional amounts associated with each of the additional deposited (e.g., a third amount associated with the third deposit, a fourth amount associated with the fourth deposit, etc.).

In some embodiments, the processing circuit is configured to determine a sum of the amounts associated with each of the deposits of the portion of the deposits that will occur during the billing period. For example, the processing circuit may add a first amount associated with a first deposit of a portion of the deposits associated with a billing period, a second amount associated with a second deposit of the portion of the deposits, and a third amount associated with a third deposit of the portion of the deposits. By summing the amounts associated with each of the deposits of the portion of the deposits that will occur during the billing period, the processing circuit may determine a total amount that will be transferred to the bill payment during the billing period. In some embodiments, the processing circuit is configured to compare the sum of the amounts associated with each of the deposits of the portion of the deposits that will occur during the billing period to a bill amount corresponding to the bill payment. For example, a first amount, a second amount, and a third amount may be associated with deposits of a portion of the deposits that will occur during a billing period with a corresponding bill amount. The processing circuit may compare the sum of the first amount, the second amount, and the third amount to the bill amount to determine if the sum of the first amount, the second amount, and the third amount is greater than, less than, or equal to the bill amount.

In some instances, the processing circuit may be configured to notify the user that the sum of the amounts associated with each of the deposits of the portion of the deposits that will occur during the billing period is less than or greater than the bill amount (e.g., through the user device 140, etc.). For example, if the sum of the amounts associated with deposits in a billing period is less than the bill amount, the processing circuit may be configured to notify the user that the amounts of the deposits that the user has allocated to the bill payment is not sufficient to cover the bill payment. For example, if the sum of the amounts associated with deposits in a billing period is $500 and the bill amount is $600, the user may be notified that the user needs to allocate an additional $100 of the deposits to the bill payment to cover the bill payment. As another example, if the sum of the amounts associated with deposits in a billing period is greater than the bill amount, the processing circuit may be configured to notify the user that the mounts of the deposits that the user has allocated to the bill payment is in excess of the bill amount of the bill payment such that the user can reduce the amounts associated with the deposits in the billing period before the deposits are received by the user.

In some instances, the processing circuit is configured to regenerate the transfer preference based on receiving an update to the preference data. In some instances, the processing circuit may receive the update to the preference data after notifying the user that the sum of the amounts associated with the deposits in the billing period is less than or greater than the bill amount. For example, after receiving the notification, the user may update the preference data through the user device. In some embodiments, the updated to the preference data may only occur for deposits that have not yet occurred. For example, the user may update the preference data during a middle of a billing period. In this case, the user may not update a first amount associated with a first deposit in the billing period that has already occurred, but the user may update a second amount associated with a second deposit in the billing period that has not yet occurred. In some instances, regenerating the transfer preferences results in the sum of the amounts associated with the deposits in the billing period equaling the billing amount of the bill payment.

In some instances, the processing circuit is configured to determine a deposit range for the deposits into an account of the person that includes a range of typical amounts (e.g., a range of typical values, etc.) of the deposits. For example, the deposit range may include a maximum value and a minimum value and a typical deposit into the account of the person may be expected to fall between the minimum value and the maximum value. In some instances, the processing circuit is configured to determine the deposit range based on the account data. For example, the processing circuit may analyze the account data and determine a deposit range for the deposits based on historical deposits into the account. For example, if the deposits are typically between $1000 and $1100, the deposit range may be between $1000 and $1100. In some embodiments, the processing circuit may determine the deposit range based on a user input of the user. For example, a user may enter a deposit range between $1500 and $1550 into the user device after receiving a new job with a higher salary, despite the fact that the account data includes deposits with lower values.

In some instances, the processing circuit is configured to validate that a value of a deposit received in an account is within the deposit range. For example, the processing circuit may compare a value of a deposit with a minimum value and a maximum value of a deposit range and determine if the value of the deposit is between the minimum value and the maximum value. For example, a person may receive a deposit that is significantly higher that a typical deposit of the person when the person receives a yearly bonus. The processing circuit may identify that the deposit containing the yearly bonus has a value that is higher than the deposit range. As another example, a person may receive a deposit that is significantly lower than a typical deposit when an expense has been removed from the deposit prior to the deposit being deposited in the account of the person. The processing circuit may identify that a value of the deposit with the expense removed is lower than the deposit range.

In some instances, responsive to the deposit not being within the deposit range, the processing circuit is configured to notify the user that the deposit is above or below the deposit range. For example, if the deposit is below the minimum value of the deposit range, the processing circuit may notify the user that the deposit is below the deposit range. As another example, if the deposit is above the maximum value of the deposit range, the processing circuit may notify the user that the deposit is above the deposit range.

In some instances, responsive to the deposit being above the deposit range, the processing circuit is configured to provide an interface to the user device corresponding to the deposit being above the deposit range. In some instances, the interface includes at least one actionable item. The actionable item may allow for a user of the user device to select the actionable item. In response to the selection of the actionable item, the processing circuit may be configured to increase the amount associated with the deposit, in some instances. For example, if a person receives a deposit corresponding to a yearly bonus that is above the deposit range, the processing circuit may increase an amount of the deposit allocated to bill payment such that the person may transfer a greater amount to the bill payment when receiving a larger deposit.

In some instances, responsive to the deposit being below the deposit range, the processing circuit is configured to provide an interface to the user device corresponding to the deposit being below the deposit range. In some instances, the interface includes at least one actionable item. The actionable item may allow for a user of the user device to select the actionable item. In response to the selection of the actionable item, the processing circuit may be configured to decrease the amount associated with the deposit, in some instances. For example, if a person receives a deposit corresponding to that is below the deposit range, the processing circuit may decrease an amount of the deposit allocated to bill payment such that the person may transfer a lesser amount to the bill payment when receiving a smaller deposit.

In some instances, the processing circuit can be further configured to determine an out of range frequency of the deposits into the account of the person. In some instances, the out of range frequency can relate to how frequently the deposits that are made into the account are out of the deposit range. For example, if a person receives a bonus annually then the processing circuit will determine that the out of range frequency of the deposits is annually. In some instances, the processing circuit may be configured to estimate a out of range frequency based on the account data.

In some instances, the processing circuit can be further configured to estimate that a deposit will not be within the deposit range based on the out of range frequency. For example, if the out of range frequency is once per year and a most recent deposit that was not within the deposit range was a year ago, the processing circuit may estimate that the next deposit will not be within the deposit range. In some instances, the processing circuit is configured to notify the user of the estimation that the deposit will not be with in the deposit range. In some instances, the processing circuit is configured to provide an out of range interface to the user device. The out of range interface may include an actionable item. In response to the selection of the actionable item, the processing circuit may be configured modify an amount associated with the deposit that was estimated to not be within the deposit range.

Once the processing circuit has received preference data related to transfer preferences of a person, the processing circuit may receive an indication that a deposit has been received by a first account, at step 304. The deposit may be received by the first account on a deposit date. In some instances, the first account corresponds to a personal account of the person. For example, the first account may be a checking account or a saving account of the person. In some instances, the processing circuit may receive the indication that the deposit has been received from the provider systems 135 or the data sources 170. In some instances, the processing circuit may receive a first indication that a first deposit has been received by the first account and a second indication that a second deposit has been received by the first account. For example, the person may receive a first paycheck and a second paycheck. The processing circuit may receive a first indication when the first paycheck is received by an account of the person and may receive a second indication when the second paycheck is received by the account of the person. In some instances, the processing circuit may receive additional indications (e.g., a third indication, a fourth indication, etc.) when the first account receives additional deposits (e.g., a third deposit, a fourth deposit, etc.).

Once the processing circuit has received the indication that the deposit has been received by the account, the processing circuit may transfer the amount from the first account to a second account, at step 306. For example, the processing circuit may receive an indication that a first account of the person has received a deposit and then may transfer an amount corresponding to the deposit from the first account to a second account. In some instances, the second account is also an account of the person. For example, the first account and the second account may be sub-accounts of main account of the person. The first account may be configured as a checking account for day to day spending of the person and the second account may be configured as a bill pay account configured to store amounts allocated for bill payments. In some instances, the second account may correspond to a bill provider of the bill payment and the transfer of the amount from the first account to the second account may correspond with the person paying the bill payment. In some instances, the processing circuit is configured to transfer a first amount from the first account to the second account after receiving the first indication that a first deposit has been received by the first account and to transfer a second amount from the first account to the second account after receiving the second indication that a second deposit has been received by the first account.

In some instances, after the processing circuit has transferred the amount associated with the deposit from the first account to the second account, the processing circuit is configured to determine if the amount associated with the deposit is less than the bill amount corresponding to the bill payment. For example, the processing circuit may transfer $5 from the first account to the second account after receiving a deposit, but a bill amount corresponding to the bill payment may be $10, meaning that the amount associated with the deposit in the second account is not sufficient to pay the bill payment. In some instances, the processing circuit is configured to transfer an additional amount from the first account to the second account equal to the difference between the bill amount and the amount associated with the deposit transferred from the first account to the second account when the amount associated with the deposit is less than the bill amount. For example, the processing circuit may transfer an additional $5 from the first account to the second account if the amount associated with the deposit transferred from the first account to the second account is $10 and the bill amount is $5. In some instances, the processing circuit may be configured to determine if a sum of the amounts associated with the portion of the deposits that have been transferred from the first account to the second account is less than the bill amount corresponding to the bill payment. For example, the processing circuit may transfer $10 associated with a first deposit from a first account to a second account and may transfer $5 associated with a second deposit from the first account to the second account. However, if the bill amount is $20, the processing circuit may additionally transfer $5 from the first account to the second account to cover the difference between the sum of the amounts associated with the portion of the deposits that have been transferred from the first account to the second account and the bill amount.

In some instances, the processing circuit may be configured to transfer the amount from the second account to a third account associated a provider associated with the bill payment. For example, the second account may be a bill payment account of a person and the processing circuit may transfer an amount associated with a deposit from a checking account to the bill payment account after receiving an indication that the deposit has been received by the checking account. The processing circuit may then transfer the amount from the bill payment account to a provider account that is associated with a provider associated with the bill payment. The transfer of the amount from the bill payment account to the provider account corresponds with paying the amount towards the bill payment. In some instances, the processing circuit is configured to transfer the amount from the second account to the third account on a payment date. In some instances, the payment date is a different date than then deposit date. For example, a person may receive a deposit on a first date and a bill payment may not be due until a second date. The processing circuit may be configured to transfer the amount from a checking account to a bill pay account on the first date and to transfer the amount from the bill pay account on the second date.

In some instances, the process of modeling can include using techniques such as machine learning, statistical analysis, and pattern recognition to establish relationships between data and parameters and generate resulting data based on those relationships. In some instances, modeling can begin with the selection of an appropriate model based on the data and the parameters. It should be understood that the term modeling herein encompasses a wide range of techniques and approaches aimed at understanding relationships within data. This could include anything from statistical methods and rule-based systems to machine learning algorithms, depending on the nature of the data. Thus, modeling involves selecting techniques based on the specific characteristics of the data, ensuring that the chosen method or methods accurately captures relationships.

In some instances, the model parameters can be trained and optimized using the cleaned, classified, and linked data and parameters. This training process can include using algorithms to adjust the model parameters such that the error between the model's predictions and the actual outcomes is minimized. The modeling process can also include feature engineering, which is the process of creating new features or modifying existing ones to improve the model's power. For example, instead of modeling a deposit frequency from a first provider with a billing frequency from a second provider to determine a variation between the deposit frequency and the billing frequency, a feature that sets the difference between a first frequency of the first provider and a second frequency of a second provider might result in a more efficient model due if the first provider always utilizes the first frequency and the second provider always utilizes the second frequency.

Once one or more models or techniques are trained and/or optimized, the processing circuits can use the model to generate resultant data. The resultant data could be a mathematical representation, a decision tree, a set of rules, or any other structure that captures the relationships between different data points. Moreover, the modeling process can include various safeguards to ensure privacy and security of user data (e.g., anonymizing the data). In some embodiments, the processing circuits can use rule-based systems to model the data and the parameters. Rule-based systems can be where predefined rules are created by the processing circuits (or domain experts) to infer outcomes based on given conditions.

In some instances, after the processing circuit has transferred the amount associated with the deposit from the first account to the second account, the processing circuit can receive new or updated preference data, billing data, and/or account data. For example, the processing circuit may be configured to continuously monitor and receive new information (e.g., from the user device 140, from the data source 170, from the provider system 135, etc.) and determine the effect on the amounts associated with the deposits, the bill amounts, or other components of the transfer system. New data can affect modeling results of the processing circuit modeling the deposit frequency and the billing frequency, comparing the sum of the amounts associated with the deposits to the bill amount, and other calculations and determinations made by the processing circuit. For example, a bill amount of a bill payment may be updated (e.g., the bill amount could be raised, the bill amount could be lowered, etc.) after the processing circuit has already determined that a sum of a first amount and a second amount associated with deposits that have been transferred from a first account to a second account associated with the bill payment. A source (e.g., user device 140, data source 170, or provider system 135) may then send an update of the new bill amount. Because updates to the bill amount can be a significant factor affecting the operations of the processing circuit, the processing circuit can compare the sum of the first amount and the second amount to the new bill amount and determine actions based on the comparison.

Referring now to FIG. 4, an illustration of a configuration of a user interface 400 on the user device 140 is shown. The user interface 400 may be presented within the user client application 154. In some embodiments, the user interface 400 is generated and provided by the content control circuit 128 and transmitted to the user device 140 to be displayed to a user.

As illustrated, the user interface 400 includes a first account indicator 402, a first amount indicator 404, and a first actionable item 406. The first account indicator 402 displays content related to a first account to the user such that the user may identify the first account. The content related to the first account may include descriptions of the first account, photographs relating to the first account, videos relating to the first account, or other elements that may relate to the first account. In some instances, the first account indicator 402 may relate to a first account associated with a person. For example, the first account indicator 402 may relate to a checking account or a savings account associated with a person.

The first amount indicator 404 displays content related to a first amount to the user such that the user may identify the first amount. The content related to the first amount may include descriptions of the first amount, values of the first amount, or other elements that may relate to the first amount. In some instances, the first amount is associated with a first deposit and the first amount indicator 404 displays content related to the second account. The content related to the first deposit may include descriptions of the first deposit, values of the first deposit, or other elements that may relate to the first deposit.

The first actionable item 406 may be associated with the first amount associated with the first deposit that may be deposited into the first account at step 304, discussed above. In some instances, the customer may select the first actionable item 406 to activate a transfer of the first amount corresponding to the first amount indicator 404 once the first deposit associated with the first amount is received by the first account. For example, in some instances, the first actionable item 406 may allow for the processing circuit to automatically transfer the first amount from the first account to a second account after the processing circuit receives an indication that the first account has received the first deposit. As another example, in some instances, the first actionable item 406 may allow for the user to adjust a value of the first amount corresponding to the first amount indicator 404. For example, the first actionable item 406 may allow for the user to increase the first amount or decrease the first amount.

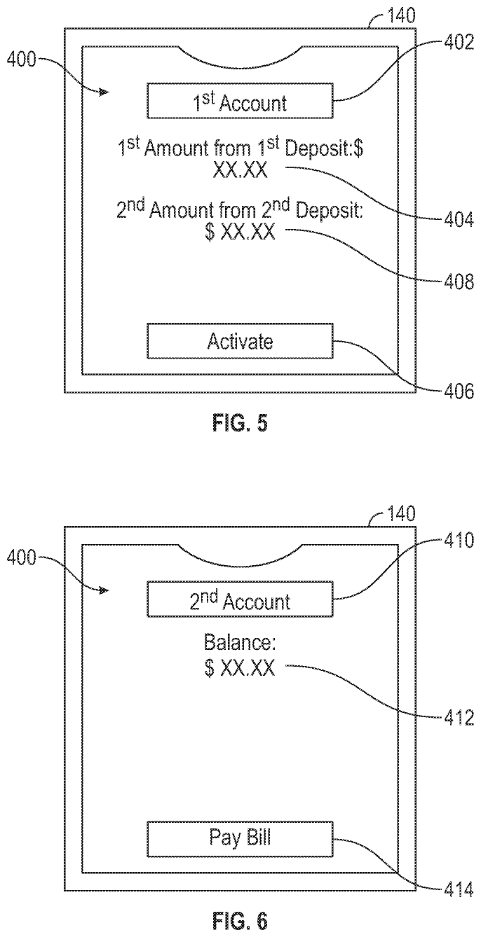

Referring now to FIG. 5, an illustration of a configuration of the user interface 400 on the user device 140 is shown. As illustrated, the user interface 400 includes the first account indicator 402, the first amount indicator 404, the first actionable item 406, and a second amount indicator 408. The second amount indicator 408 displays content related to a second amount to the user such that the user may identify the second amount. The content related to the second amount may include descriptions of the second amount, values of the second amount, or other elements that may relate to the second amount. In some instances, the second amount is associated with a second deposit and the second amount indicator 408 displays content related to the second deposit. The content related to the second deposit may include descriptions of the second deposit, values of the second deposit, or other elements that may relate to the second deposit.

In some instances, the first actionable item 406 be additionally associated with the second amount associated with the second deposit that may be deposited into the first account, discussed above. In some instances, the customer may select the first actionable item 406 to activate a transfer of the second amount corresponding to the second amount indicator 408 once the second deposit associated with the second amount is received by the first account. For example, in some instances, the first actionable item 406 may allow for the processing circuit to automatically transfer the second amount from the second account to a second account after the processing circuit receives an indication that the second account has received the second deposit. As another example, in some instances, the first actionable item 406 may allow for the user to adjust a value of the second amount corresponding to the second amount indicator 408. For example, the first actionable item 406 may allow for the user to increase the second amount or decrease the second amount.

Referring now to FIG. 6, an illustration of a configuration of the user interface 400 on the user device 140 is shown. As illustrated, the user interface includes a second account indicator 410, a second account balance indicator 412, and a second actionable item 414. The second account indicator 410 displays content related to a second account to the user such that the user may identify the second account. The content related to the second account may include descriptions of the second account, photographs relating to the second account, videos relating to the second account, or other elements that may relate to the second account. In some instances, the second account indicator 410 may relate to a second account associated with a person. For example, the second account indicator 410 may relate to a bill pay account of a person that is configured to make bill payments for the person.

The second account balance indicator 412 displays content related to the second account of the user such that the user may identify a balance of the second account. The content related to the second account may include a balance in the second account. For example, the second account balance indicator 412 may include an identification that the second account has a balance of $54.40.

The second actionable item 414 may be associated with the second account that receives the transfer from the first account at step 306, discussed above. In some instances, the customer may select the second actionable item 414 to activate a transfer of the balance of the second account to a third account associated with a provider. The provider may be associated with the bill payment. For example, in some instances, the second actionable item 414 may allow for the processing circuit to transfer the balance of the second account to a third account operated by a provider of the bill payment such that the bill payment is paid off by the balance of the second account. In some instances, the second actionable item 414 may allow for the user to transfer a portion of the balance of the second account to the third account. For example, the balance of the second account may be greater than the bill amount associated with the bill payment. The second actionable item 414 may allow for the user to transfer an amount from the second account to the third account that is equal the bill amount such that the user can pay off bill payment without transferring an excess amount.

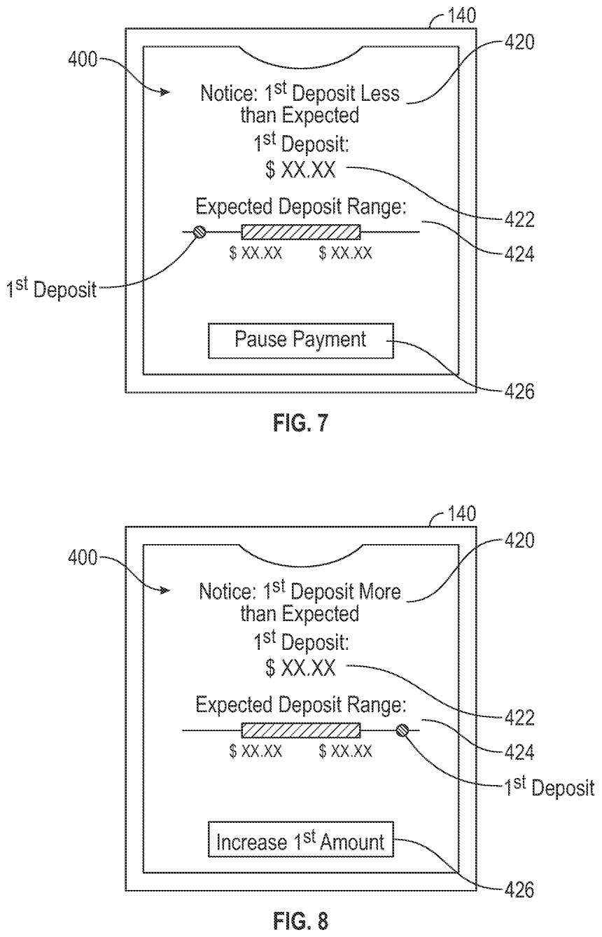

Referring now to FIG. 7, an illustration of a configuration of the user interface 400 on the user device 140 is shown. As illustrated, the user interface includes a notification 420, a deposit indicator 422, a deposit range indicator 424, and a third actionable item 426. The notification 420 may include content related to a deposit into the first account that allow the user to identify a situation associated with the deposit. For example, the notification 420 may include a description of a situation associated with the deposit, a photograph related to the situation associated with the deposit, or other content related to the situation associated with the deposit. For example, the situation associated with the deposit may be that the deposit is outside of a deposit range associated with deposits and the notification 420 may identify if the deposit is above the deposit range or below the deposit range. The deposit indicator 422 displays content related to a deposit to the user such that the user may identify the deposit. The content related to the deposit may include descriptions of the deposit, values of the deposit, or other elements that may relate to the deposit.

The deposit range indicator 424 may include visual content relating to the situation associated with the deposit. For example, the deposit range indicator 424 may include a graph illustrating the deposit range and a marker indicating how the deposit relates to the deposit range. For example, the deposit range indicator 424 may be a bar with a maximum deposit of the deposit range and a minimum deposit of the deposit range. If the deposit is below the deposit range, the marker may be positioned to the left of the minimum deposit. If the deposit is above the deposit range, the marker may be positioned to the right of the minimum deposit. In some instances, deposit range indicator 424 may include a variety of text-based, color-based, or symbol-based indicator indicative of the relationship between the deposit and the deposit range. For example, deposit range indicator 424 may include one or more of a color-coded indicator (e.g., a green indicator that the deposit is within the deposit range, a yellow indicator that the deposit is above the deposit range, a red indicator that the deposit is below the deposit range), a predetermined shape-based symbol (e.g., a plus sign that the deposit is above the deposit range, an equal sign that the deposit is within the deposit range, a minus sign that the deposit is below the deposit range), or any other suitable type of the deposit range indicator 424.

The third actionable item 426 may be associated with the deposit being outside of the deposit range, as discussed above. In some instances, the customer may select the third actionable item 426 to modify an action taken by the processing circuit after the processing circuit has determined that the deposit is outside of the deposit range. For example, in some instances, the selection of the third actionable item 426 may cause the processing circuit to pause transferring the amount associated with the deposit from the first account to the second account if the deposit is below the deposit range. For example, the customer may desire to pause the transfer of the amount associated with the deposit from the first account to the second account if the deposit is below the deposit range because the customer may need the amount associated with the deposit to afford other necessities due to the deposit being less than normal. As another example, in some instances, the selection of the third actionable item 426 may cause the processing circuit to increase a value of the amount associated with the deposit before transferring the amount from the first account to the second account. For example, the customer may desire to increase the value of the amount if the deposit is above the deposit range because the customer may be able to afford to transfer more from the first account to the second account due to the deposit being above the deposit range.

Referring now to FIG. 8, an illustration of a configuration of the user interface 400 on the user device 140 is shown. As illustrated, the user interface includes the notification 420, the deposit indicator 422, the deposit range indicator 424, and the third actionable item 426.

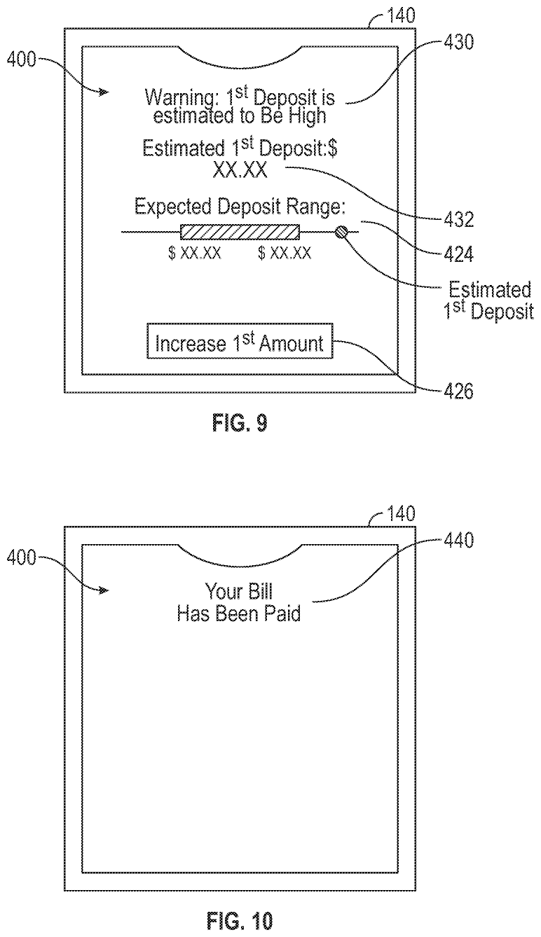

Referring now to FIG. 9, an illustration of a configuration of the user interface 400 on the user device 140 is shown. As illustrated, the user interface includes a warning 430, an estimated deposit indicator 432, the deposit range indicator 424, and the third actionable item 426. The warning 430 may include content related to an estimated deposit into the first account that has not yet occurred that allow the user to identify a situation associated with the estimated deposit. For example, the warning 430 may include a description of a situation associated with the estimated deposit, a photograph related to the situation associated with the estimated deposit, or other content related to the situation associated with the estimated deposit. For example, the situation associated with the estimated deposit may be that the estimated deposit is estimated to be outside of a deposit range associated with deposits and the warning 430 may identify if the estimated deposit is estimated to be above the deposit range or below the deposit range. The warning 430 may allow for the user to make a decision regarding the estimated deposit before the estimated deposit is deposited into the first account. The estimated deposit indicator 432 displays content related to the estimated deposit to the user such that the user may identify the estimated deposit. The content related to the estimated deposit may include descriptions of the estimated deposit, estimated values of the estimated deposit, or other elements that may relate to the estimated deposit. The deposit range indicator 424 may include visual content relating to the situation associated with the estimated deposit similar to the deposit range indicator 424 described in relation to the deposit above. The third actionable item 426 may allow for the user to modify an amount associated with the estimated deposit similar to the deposit range indicator 424 described in relation to the deposit above.

Referring now to FIG. 10, an illustration of a configuration of the user interface 400 on the user device 140 is shown. As illustrated, the user interface includes a confirmation 440. The confirmation 440 may include content related to a transfer of an amount towards a bill payment. For example, the confirmation 440 may include content related to transferring an amount from a first account associated with a person to a second account associated with a provider of a bill payment. The confirmation 440 may allow for the user to confirm that the amount was transferred to the provider of the bill payment such that the user is aware that a payment was made toward the bill payment. In some instances, the confirmation 440 may include content related to the transfer such as a description of the transfer, a value of an amount that was transferred, or other content related to the transfer.

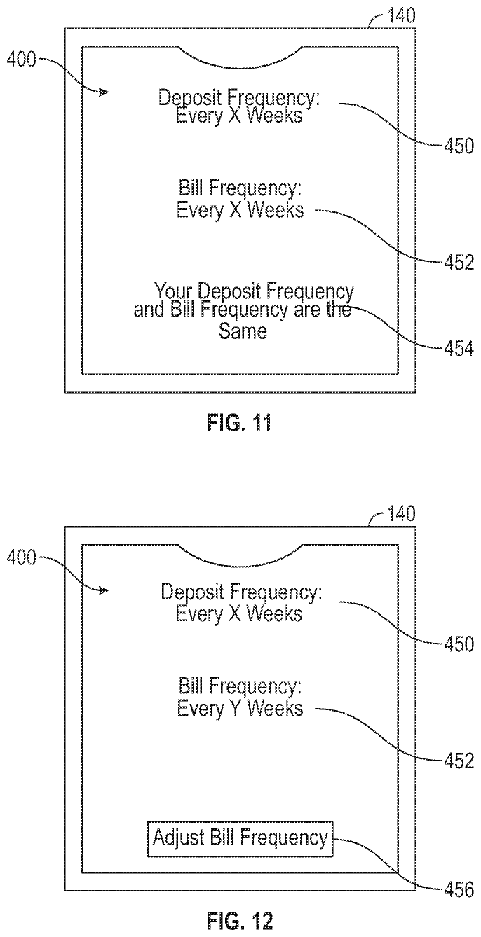

Referring now to FIG. 11, an illustration of a configuration of the user interface 400 on the user device 140 is shown. As illustrated, the user interface includes a deposit frequency indicator 450, a bill frequency indicator 452, and a variation indicator 454. In some instances, the user interface is configured as a variation interface. The deposit frequency indicator 450 displays content related to a deposit frequency of deposits into the first account. The content related to the deposit frequency may include descriptions of the deposit frequency, frequencies of the deposit frequency, or other elements that may relate to the deposit frequency. The bill frequency indicator 452 displays content related to a bill frequency of bills payments. The content related to the bill frequency may include descriptions of the bill frequency, frequencies of the bill frequency, or other elements that may relate to the bill frequency. The variation indicator 454 displays content related to a variation between the deposit frequency and the bill frequency. The content related to the variation may include descriptions of the variations between the deposit frequency and the bill frequency, a valuation of the variation between the deposit frequency and the bill frequency, or other elements that may relate to the variation. For example, the variation indicator 454 may include content indicating that the deposit frequency and the bill frequency are the same if the variation between the deposit frequency and the bill frequency is zero.

Referring now to FIG. 12, an illustration of a configuration of the user interface 400 on the user device 140 is shown. As illustrated, the user interface includes a deposit frequency indicator 450, a bill frequency indicator 452, a fourth actionable element 456. The fourth actionable element 456 may be associated with the variation between the deposit frequency and the bill frequency, as discussed above. In some instances, the customer may select the fourth actionable item 556 to modify the bill frequency to eliminate the variation between the deposit frequency and the bill frequency. In some instances, the customer may select the fourth actionable item 556 to modify the deposit frequency to eliminate the variation between the deposit frequency and the bill frequency.

It should be understood that no claim element herein is to be construed under the provisions of 35 U.S.C. § 112 (f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions and arrangement of the embodiments without departing from the scope of the present disclosure as expressed in the appended claims.

What is claimed is:

1. A system comprising:
a processing circuit comprising memory and one or more processors, the processing circuit configured to:
determine a billing period based on a billing frequency corresponding to a bill payment;
determine a portion of deposits that will be made into a first account that will occur during the billing period before the portion of the deposits have occurred;
generate transfer preferences for the portion of the deposits based on receiving, from a graphical user interface (GUI) of a user device, preference data corresponding to the portion of the deposits, the transfer preferences including amounts associated with each deposit of the portion of the deposits that will be allocated to the bill payment;
receive an indication that a deposit of the portion of the deposits has been received by the first account; and
transfer an amount associated with the deposit from the first account to a second account, wherein the second account is associated with the bill payment and the amount transferred is based on a bill payment amount.

2. The system of claim 1, wherein the preference data further includes a provider associated with the bill payment;
wherein the deposit is received by the first account on a deposit date; and
wherein the processing circuit is further configured to:
transfer the amount from the second account to a third account associated with the provider on a payment date, wherein the payment date and the deposit date are different dates.

3. The system of claim 2, wherein the first account and the second account are sub-accounts that belong to a main account.

4. The system of claim 1, wherein the processing circuit is further configured to:
determine that a sum of the amounts associated with each of deposits of the portion of the deposits is not equal to a bill amount corresponding to the bill payment;
generate and provide, to the GUI of the user device, a notification that the sum of the amounts associated with each of the deposits of the portion of the deposits is not equal to the bill amount; and
regenerate the transfer preferences based on receiving, from the GUI of the user device, an update to the preference data corresponding to the amount associated with at least one of the deposits that has not yet occurred of the portion of the deposits, wherein the sum of the amounts associated with each of the deposits is equal to the bill amount.

5. The system of claim 1, wherein the billing period is a first billing period, the amounts are first amounts, and the portion of the deposits is a first portion of the deposits;
wherein the processing circuit is further configured to:
determine a second billing period based on the billing frequency;
determine a second portion of the deposits that will occur during the second billing period before the second portion of the deposits have occurred; and
regenerate the transfer preferences for the second portion of the deposits that have not yet occurred based on receiving, from the GUI of the user device, an update to the preference data corresponding to the second portion of the deposits, the transfer preferences including second amounts associated with each deposit of the second portion of the deposits;
wherein a first quantity of the deposits in the first portion of the deposits is not equal to a second quantity of the deposits in the second portion of the deposits.

6. The system of claim 1, wherein the indication is a first indication, the deposit is a first deposit, and the amount is a first amount; and
wherein the processing circuit is further configured to:
receive a second indication that a second deposit of the portion of the deposits has been received by the first account; and
transfer a second amount associated with the second deposit from the first account to the second account.

7. The system of claim 6, wherein the first amount is not equal to the second amount.

8. The system of claim 7, wherein the processing circuit is further configured to:
determine that a sum of the first amount and the second amount is less than a bill amount corresponding to the bill payment; and
transfer a third amount equal to a difference between the bill amount and the sum of the first amount and the second amount from the first account to the second account.

9. The system of claim 1, wherein the processing circuit is further configured to:
determine the billing frequency for the bill payment based on previous transfers from the first account to the second account.

10. The system of claim 1, wherein the processing circuit is further configured to:
determine a deposit frequency for the deposits based on previous deposits into the first account;
model the deposit frequency with the billing frequency to identify a variation between the deposit frequency and the billing frequency;
generate and provide, by the GUI of the user device, a variation interface corresponding to the variation, wherein the variation interface comprises at least one actionable element; and
wherein in response to a selection of the at least one actionable element, the processing circuit is further configured to modify the billing frequency to eliminate the variation between the billing frequency and the deposit frequency.

11. A system comprising:
a processing circuit comprising memory and one or more processors, the processing circuit configured to:
determine a deposit range for deposits that will be made into a first account, the deposit range including a range of typical values of the deposits;
configure transfer preferences for a portion of the deposits into the first account based on receiving, from a graphical user interface (GUI) of a user device, preference data corresponding with the portion of the deposits before the portion of the deposits have occurred, the transfer preferences including an amount associated with each deposit in the portion of the deposits;
receive an indication that one of the deposits in the portion of the deposits has been received by the first account;
validate that the one of the deposits is within the deposit range;
responsive to the one of the deposits not being within the deposit range, generate and provide a notification to the GUI of the user device, the notification indicating that the one of the deposits is at least one of below the deposit range or above the deposit range; and
responsive to the one of the deposits being within the deposit range, transfer the amount associated with the one of the deposits from the first account to a second account, wherein the second account is associated with a bill payment.

12. The system of claim 11, wherein responsive to the one of the deposits being above the deposit range, the processing circuit is further configured to:
generate and provide, the GUI of the user device, an interface corresponding to the one of the deposits being above the deposit range, wherein the interface comprises at least one actionable element;
wherein in response to a selection of the at least one actionable element, the processing circuit is further configured to increase the amount associated with the one of the deposits; and
transfer the amount associated with the one of the deposits from the first account to the second account.

13. The system of claim 12, wherein the amount is a first amount and the one of the deposits is a first deposit; and
wherein the processing circuit is further configured to:
decrease a second amount associated with a second deposit in the portion of the deposits.

14. The system of claim 11, wherein responsive to the one of the deposits being below the deposit range, the processing circuit is further configured to:
generate and provide, by the GUI of the user device, an interface corresponding to the one of the deposits being below the deposit range, wherein the interface comprises at least one actionable element;
wherein in response to a selection of the at least one actionable element, the processing circuit is further configured to decrease the amount associated with the one of the deposits; and
transfer the amount associated with the one of the deposits from the first account to the second account.

15. The system of claim 14, wherein the amount is a first amount and the one of the deposits is a first deposit; and
wherein the processing circuit is further configured to:
increase a second amount associated with a second deposit in the portion of the deposits.

16. The system of claim 11, wherein the one of the deposits is a first deposit and the amount is a first amount; and
wherein the processing circuit is further configured to:
determine an out of range deposit frequency for the deposits not within the deposit range based on the deposits that have previously been deposited into the first account and were not within the deposit range;
estimate that a second deposit in the portion of the deposits will not be within the deposit range based on the out of range deposit frequency;
generate and provide, to the GUI of the user device, an out of range interface corresponding to the second deposit, wherein the out of range interface comprises at least one actionable element; and
wherein in response to a selection of the at least one actionable element, the processing circuit is further configured to modify a second amount associated with the second deposit.

17. The system of claim 16, wherein the second deposit is estimated to be below the deposit range; and
prior to validating that the first deposit is within the deposit range, the processing circuit is configured to increase the first amount associated with the first deposit.

18. A method comprising:
determining a billing period based on a billing frequency corresponding to a bill payment;
determining a portion of deposits into a first account that will occur during the billing period before the portion of the deposits have occurred;
configuring transfer preferences for the portion of the deposits that have not yet occurred based on receiving, from a graphical user interface (GUI) of a user device, preference data corresponding to the portion of the deposits, the transfer preferences including an amount associated with each deposit of the portion of the deposits;
receiving an indication that a deposit of the portion of the deposits has been received by the first account; and
transferring the amount associated with the deposit from the first account to a second account, wherein the second account is associated with the bill payment.

19. The method of claim 18, further comprising:
determining a deposit frequency for the deposits based on previous deposits into the first account;
modeling the deposit frequency with the billing frequency to generate a variation between the deposit frequency and the billing frequency;
generating and providing, by the GUI of the user device, an interface corresponding to the variation, wherein the interface comprises at least one actionable element; and
wherein in response to a selection of the at least one actionable element, modifying the billing frequency to eliminate the variation between the billing frequency and the deposit frequency.

20. The method of claim 18, wherein the deposit is a first deposit, the indication is a first indication, and the amount is a first amount; and
wherein the method further comprises:
determining a deposit range for the deposits into the first account, the deposit range including a range of typical amounts of the deposits;
receive a second indication that a second deposit in the portion of the deposits has been received by the first account;
validate that the second deposit is within the deposit range; and
responsive to the second deposit not being within the deposit range, generate and provide a notification to the GUI of the user device, the notification indicating that the second deposit is at least one of below the deposit range or above the deposit range.
